(19) United States
(12) Patent Application Publication
(10) Pub. No.: US 2003/0025046 A1
(43) Pub. Date: Feb. 6, 2003

(54) Decorative lighting track

(76) Inventors: Jack V. Miller, Seaford, DE (US); Ruth E. Miller, Seaford, DE (US)

Correspondence Address: JACK V. MILLER, 20915 Sussex Highway 13, Seaford, DE, 19973, US

(21) Appl. No.: 09/920,110

(22) Filed: Aug. 2, 2001

(51) Int. Cl. F16L 3/00

(52) U.S. Cl. 248/49

(57) ABSTRACT

A lighting track is in the form of elongated, U-shaped metallic track with parallel depending legs having elongated decorative strips engaged and retained in dovetail slots in the exterior leg surfaces.

In a first preferred embodiment the depending legs are normal to the base of the U and are of equal length.

In a second preferred embodiment the parallel depending legs are canted from normal to the base of the U and are of unequal length.

### BACKGROUND—FIELD OF THE INVENTION

This invention relates to the field of lighting, and particularly to tracklight systems using elongated tracks that are normally attached to a ceiling and contain electrical conductors connected through a fixture adapter to a number of light fixtures.

### BACKGROUND—DESCRIPTION OF PRIOR ART

Prior art tracks are in the shape of an inverted U-shape, universally made of extruded aluminum with exterior surfaces painted white or black. The luminaires are bare reflector lamps, cylindrical metal cans or balls similarly painted. The result is a purely functional tracklight system, usually creating an ugly, cluttered ceiling, without aesthetic values.

### OBJECTS OF THE INVENTION

The principal object of the present invention is to provide a lighting track with decorative aesthetics that may be selected by a user from a variety of styles, including personalized custom designs.

### SUMMARY OF THE INVENTION

A lighting track system according to the present invention comprises a track with recesses on its visible surfaces that retain elongated decorative strips to match or compliment the aesthetics of the room.

### ADVANTAGES OF THE INVENTION

The present invention achieves the object of the invention by providing decorative elements on the track and that may be selected from an inventory or custom made for a customer, such as a restaurant, hotel or retail chain. Another advantage is that the decorative elements may be added to “plain” tracks according to the invention, or may be changed after installation to change the decorative theme.

### BRIEF DESCRIPTION OF THE DRAWINGS

FIG. 1 is a perspective view of a prior-art lighting track from applicant's U.S. Pat. No. 4,822,292.

FIG. 2 is a perspective view of a lighting track according to the present invention, showing installation of a decorative strip;

FIG. 3 is a cross-sectional view of a first preferred embodiment of the track of FIG. 2, taken along section line 3-3;

FIG. 4 is a perspective cross-sectional view of a second preferred embodiment of the track of FIG. 2 including an embossed, pierced strip;

FIG. 5 is a perspective cross-sectional view of a third preferred embodiment of the track of FIG. 2 including an extruded decorative strip;

FIG. 6 is a perspective cross-sectional view of a fourth preferred embodiment of the track of FIG. 2 including an embossed wood moulding;

FIG. 7 is a perspective cross-sectional view of a fifth preferred embodiment of the track of FIG. 2 including a wood cornice moulding; and

FIG. 8 is a perspective cross-sectional view of a sixth preferred embodiment of the present invention, mountable by one leg of a U-shaped track having a base and parallel legs oblique to the base of the U.

### REFERENCE NUMERALS IN DRAWINGS

1 prior art track 2. Base of U-shaped track

3 first depending leg 4 second depending leg

5. shallow recesses 10 track per the invention

12 base of the U-shaped track 13 first depending leg

14 second depending leg 15 dovetail recesses

16 decorative strip 17 extruded strip

18 embossed wood moulding 19 wood cornice moulding

20 side mounting track 22 base of side-mount track

23 first oblique leg 24 second oblique leg

25 first dovetail groove 26 first decorative strip

27 second dovetail groove 28 second decorative strip

### DETAILED DESCRIPTION OF THE DRAWINGS

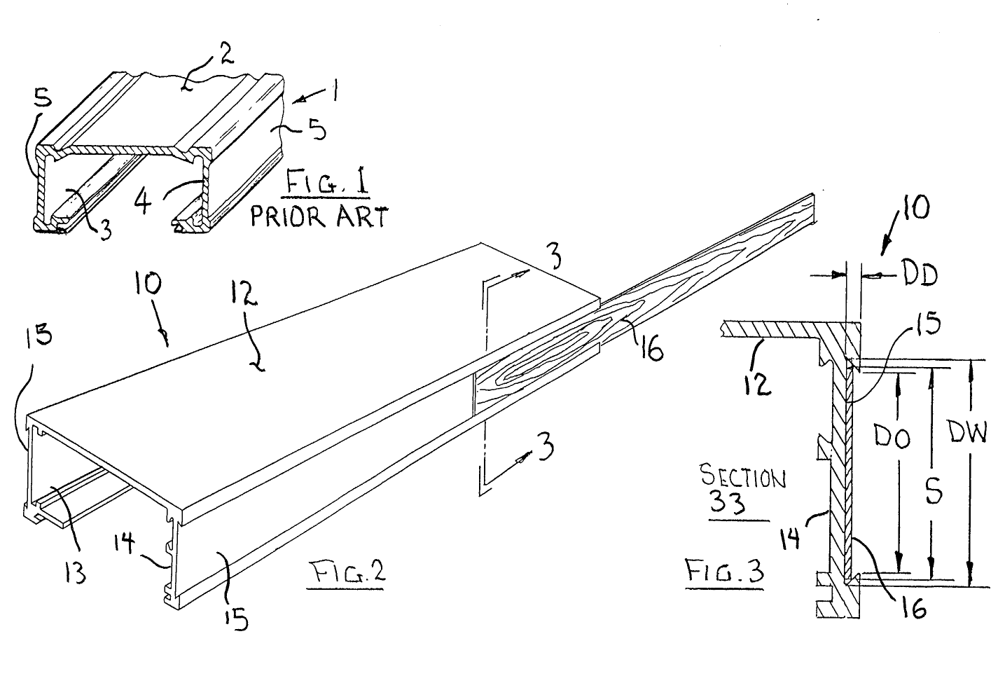

In FIG. 1 a perspective view of a lighting track 1 according applicant Jack V. Miller's prior-art U.S. Pat. No. 4,822,292 is shown in a typically-used inverted U-shape having a base 2 adapted for ceiling mounting, and a pair of parallel depending legs 3 and 4, depending from base 2. Shallow recesses 5 break up the appearance of the legs, but provide no attachment means for decorative elements.

In FIG. 2 a U-shaped lighting track 10 according to the present invention is shown in perspective, including a base 12, depending legs 13, 14, having dovetail recesses 15. A decorative strip 16 is shown sliding into dovetail groove 15.

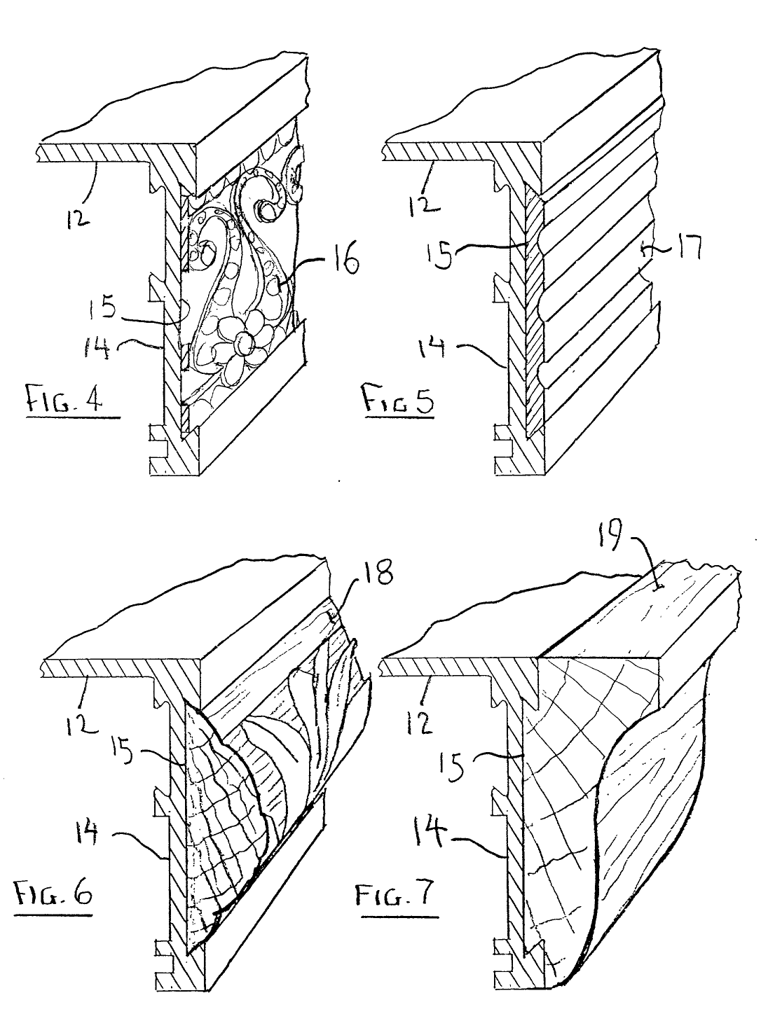

FIG. 3 is a partial transverse cross-sectional view taken along section 3-3 of FIG. 2, showing track base 2 and a depending leg 14 having a recessed dovetail groove 15. Dovetail groove 15 has a dovetail opening DO and a dovetail width DW at a depth DD, wide enough and deep enough to capture decorative strip 16 and retain it in the track. Decorative strips 16 may be solid colors, printed patterns, or even thin wood veneer strips made to the width S that would be wider than DO and narrower than DW.

FIG. 4 is a partial perspective cross-sectional view of a track according to the invention showing track base 12 and a depending leg 14 having a recessed dovetail groove 15. Dovetail groove 15 is shown retaining a decorative, perforated metal strip of a width S of FIG. 3.

FIG. 5 is a partial perspective cross-sectional view of a track according to the invention showing track base 12 and a depending leg 14 having a recessed dovetail groove 15. Dovetail groove 15 is shown retaining a decorative, extruded strip having angular edges matching the dovetail sides.

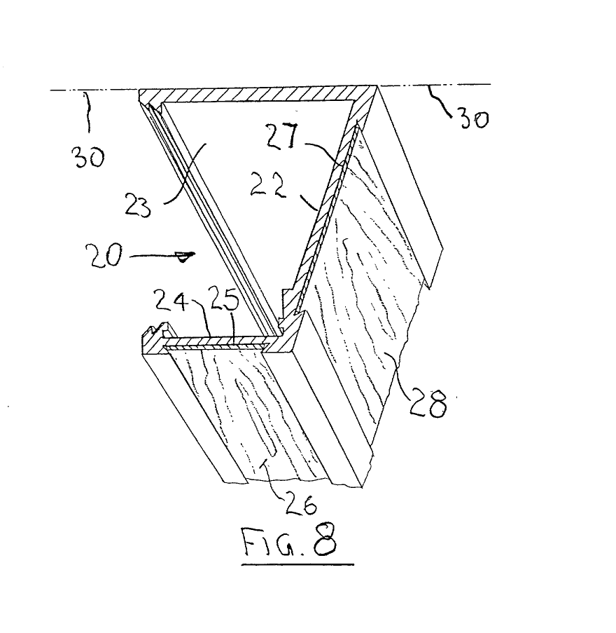

FIG. 6 is a partial perspective cross-sectional view of a track according to the invention showing track base 12 and a depending leg 14 having a recessed dovetail groove 15. Dovetail groove 15 is shown retaining a decorative, embossed wood half-round moulding having angular edges matching the dovetail sides.

FIG. 7 is a partial perspective cross-sectional view of a track according to the invention showing track base 12 and a depending leg 14 having a recessed dovetail groove 15. Dovetail groove 15 is shown retaining a decorative, wood crown moulding having angular edges matching the dovetail sides.

In FIG. 8 a U-shaped lighting track 20 according to the present invention is shown in perspective. A first leg 23 of the U-shape 21 is mountable to a ceiling 30, and depending base 22 of the U joined at an acute angle to leg 23. Base 22 is also joined at an obtuse angle to leg 24, parallel to leg 23. Legs 23 and 24, each have a dovetail recess 25 and 28, with a decorative strip 26 and 27 shown in dovetail grooves 28 and 29, respectively.

### SUMMARY, RAMIFICATIONS AND SCOPE

A lighting track is a U-shaped metallic track with parallel depending legs having elongated decorative strips engaged and retained in dovetail slots in the exterior leg surfaces. In a first preferred embodiment the depending legs are normal to the base of the U and are of equal length.

In a second preferred embodiment the parallel depending legs are canted from normal to the base of the U and are of unequal length.

1. A lighting track comprising:
an elongated, U-shaped metallic track having exterior surfaces, said track having a base and first and second parallel depending legs with proximal ends extending from the base of the U to distal ends in a common plane;
a dovetail slot in the exterior surface of at least one depending leg; and
an elongated decorative strip engaged and retained each dovetail slot.

2. A lighting track according to claim 1 in which the first leg of the U at an acute angle and the second leg depends from the base of the U at an obtuse angle, said legs having their distal ends in a common plane; and
a dovetail slot in the exterior surface of the second depending leg;
a dovetail slot in the exterior surface of the base of the U; and
elongated decorative strips engaged and retained in the dovetail slots.

3. A lighting track according to claim 1 in which the elongated decorative strips are selected from the group including plastic, extruded metal, pierced sheet metal and wood mouldings.

3. A lighting track according to claim 2 in which the elongated decorative strips are selected from the group including plastic, extruded metal, pierced sheet metal and wood mouldings.
